(19) United States
(12) Patent Application Publication
(10) Pub. No.: US 2003/0093716 A1
(43) Pub. Date: May 15, 2003

(54) Method and apparatus for collecting persistent coverage data across software versions

(75) Inventors: Eitan Farchi, Pardes Hana (IL); Thomas Joseph Pavela, San Jose, CA (US); Shmuel Ur, Shorashim (IL); Avi Ziv, Haifa (IL)

Correspondence Address: INTERNATIONAL BUSINESS MACHINES CORP, IP LAW, 555 BAILEY AVENUE , J46/G4, SAN JOSE, CA, 95141, US

(73) Assignee: International Business Machines Corporation, Armonk, NY

(21) Appl. No.: 09/990,802

(22) Filed: Nov. 13, 2001

(51) Int. Cl. H04B 1/74

(52) U.S. Cl. 714/34

(57) ABSTRACT

A method, apparatus and article of manufacture for persistent code coverage data collection are provided. Initially, a program for which code coverage data should be collected is identified and divided into code coverage tasks (i.e. basic blocks) and each code coverage task is given a unique name. Coverage points are then inserted into the program source code at the beginning of each coverage task to produce an instrumented program. The instrumented program is then compiled and link-edited with an appropriate library to produce a program executable. A set of test cases to be run for a persistent code coverage data collection purposes is identified next. Then, the code coverage database is created using the identified code coverage tasks and the test cases. The program executable is loaded and run with the set of identified test cases to write coverage point information into an output file. The output file is then processed in order to populate the code coverage database with the code coverage data per each code coverage task. When the program is modified, the new and modified code coverage tasks and the new test cases identified and the code coverage database is updated accordingly. The code coverage data for the non-affected code coverage tasks is preserved for testing of the new version of the program eliminating the need for running the entire test bucket. The code coverage database may be queried to determine which test cases need to be rerun.

### BACKGROUND OF THE INVENTION

1. Field of the Invention

This invention relates in general to the testing of computer software systems. More particularly, the present invention relates to a method and system for collecting persistent code coverage data across software versions that identifies which subset of a test suite must be run in order to test a new version of a software system.

2. Description of the Related Art

The testing of software during program development, from unit testing to functional and regression testing, is an ongoing task. In particular, to perform regression testing, the program is executed many times using regression test cases as input. Running these test cases and analyzing the test results are time-consuming efforts. The challenge of delivering quality tested code products has never been greater. The goal of testing is to verify the quality and functionality of new and modified software program products. As the size and complexity of a program increases, so does the amount of testing needed. Finding the right tools and processes to provide a better-tested product is very difficult. Investing in the wrong tools or processes can be costly and possibly fatal for the product. A code coverage (i.e. test coverage) analysis tool is a wise investment in analyzing the program code and detecting defects in the product. Code coverage analysis is the process of: finding areas of a program not exercised by a set of test cases; creating additional test cases to increase coverage; and determining a quantitative measure of code coverage, which is an indirect measure of quality. An optional aspect of code coverage analysis is: identifying redundant test cases that do not increase coverage. A code coverage analysis tool automates this process.

Studies show that with 100% code coverage at the unit-testing phase, 15% of the defects in the product are detected. Another 45% of the defects are found in the functional test phase. Questions that arise when evaluating a code coverage analysis tool include the following: Will a code coverage analysis tool really be a benefit? How does one collect code coverage data in a large-scale development project when the code is constantly changing? How does one store all of the data for a module that most of the test cases exercise?

A problem arises when the code coverage data is retained across different releases of the product. When the product makes code changes or comes out with another release of the product, new code coverage data needs to be collected. This entails running the entire test case suite including the new test cases and the regression test cases. Rerunning the entire test case suite may not be feasible due to scheduling constraints.

With a code coverage analysis tool one can make intelligent decisions on what testing is needed. One can query the code coverage information and answer a number of questions:

1. What code has not been tested?

2. What are the test cases overlaps and which test cases can be deleted or combined?

3. When a code change is made to a module, what test cases need to be run?

4. When a set of test cases is run for changed code, what is the code coverage of the changed code?

5. Are new test cases needed for the new code?

6. If a defect was found, was the code tested? Were there test cases that exercised the defected area? (Casual Analysis).

7. What test cases are finding problems? Which ones are good candidates for regression testing?

Through this analysis, the testing cycle time can be reduced because selective test cases are executed as opposed to randomly selecting test cases or running the entire test case suite.

Now that it has been established that a code coverage analysis tool will help in delivering a better-tested product, the characteristics of a hypothetical large project will be examined. This hypothetical large project has over 10 million lines of code, over 3000 modules with a test suite of over 10,000 test cases. The average release for the project is about one half million lines of new or changed code with over 500 new test cases. To run the entire 10,500 test cases may take approximately 3 months to accomplish but the schedule may only allow for 2 months of testing. One simple choice is to forget about collecting code coverage data, but this may not be a wise choice. A better choice is to run only the new test cases and the regression test cases that are affected. To do this the code coverage data needs to be retained. Each line of code needs to be saved with the test cases that exercise the code. The code coverage data and the new and changed code need to be merged together identifying the test case suite to be executed.

During the testing phase of a project, new test cases are being executed to validate the product. Code defects are found and fixed during this phase. How does one gather code coverage data during this testing phase? If one takes the approach of freezing the code, i.e. not allowing any changes, while collecting the code coverage data, there will be a never-ending loop. Under this model, changes cannot be made to the code until after the code coverage data collection process is complete and the code can be un-frozen. Once the code has been changed, the code coverage data collection process must be repeated, and so on. If code coverage data collection is delayed until the functional testing phase is over, the benefits of a code coverage analysis tool are not reaped. Also, the problem of continuous code changes being integrated into the product still exists, even though the changes may not be as frequent during later testing phases.

Another problem that arises with a large project is the amount of code coverage data that is generated. The question arises as to whether data for every test case should be saved for each line of code. Some code is common code, such as initialization code, and will be touched by all test cases. With 10,000 test cases and 10 million lines of code, a very large database will be needed to store each line of code and each test case that exercised that line of code.

There exist today many code coverage analysis systems in the industry. For example, in one system, as tests are executed, each line of a test matrix that is executed is marked as such. This provides not only an indication of how many paths were executed by a given test, but also which specific paths. As the matrix is updated during all testing, it will be clear which paths have not been tested, and therefore what additional tests are needed to reach the target percentage of code coverage. “Automatic Unit Text Matrix Generation” IBM Technical Disclosure Bulletin Vol. 37, No. 6A (June, 1994).

Other systems also provide a way to execute test cases and determine the effectiveness or coverage of the testing. See e.g., “Software Test Coverage Measurement” IBM Technical Disclosure Bulletin Vol. 39, No. 8 (August, 1996); and Bradley et al., “Determination of Code Coverage” IBM Technical Disclosure Bulletin Vol. 25, No. 6 (November, 1982).

In yet another system, described in U.S. Pat. No. 5,673,387 to Chen et al., when a software system is changed, the set of changed entities (i.e. types, functions, variables and macros) are identified. This set of changed entities is then compared against each set of covered entities for the test units. If one of the covered entities of a test unit has been identified as changed, then that test unit must be rerun. A user may generate a list of changed entities to determine which test units must be rerun in the case of a hypothetical system modification.

In yet another system, described in U.S. Pat. No. 5,778,169 to Reinhardt, a test coverage matrix is generated based on the executed regression tests and the coverage points which are inserted into the source code. A programmer can then use a test coverage tool to identify a subset of tests that executed a coverage point(s) corresponding to modified statements. This saves the programmer development time because the programmer can now run the subset of tests on an executable, compiled from the source code including the modified statements, and does not have to run the complete set of regression tests.

In yet another system, described in U.S. Pat. No. 5,805,795 to Whitten, a method for selecting a set of test cases that may be used to test a software program product is disclosed. The method includes identifying each of the code blocks in the program that may be exercised, and determining a time for executing each of the test cases in the set. A set of the test cases that exercises a maximum number of the identified code blocks in a minimum time is then selected.

In yet another system, described in U.S. application Ser. No. 09/286,771 filed on Apr. 6, 1999, by Thomas J. Pavela, the code coverage data that may be stored in a database is updated or re-sequenced when code changes are made to a program. The dynamic re-sequencing of the code coverage data eliminates the need to freeze the program code while collecting the code coverage data.

These past systems merely collect and store code coverage data and report on the data collected. Additionally, they describe how to collect more and better data to determine what test cases should be run or rerun.

However, none of these prior systems provide a tool or methodology to collect, manage, preserve, keep track of and integrate persistent code coverage data across various versions of a software program product. Persistent code coverage data is a previously collected code coverage data for the non-affected parts of the program, which is preserved for the modified version of the program eliminating the need for running the entire test bucket (i.e. test case collection).

### SUMMARY OF THE INVENTION

To overcome the limitations of the prior art, and to overcome other limitations that will become apparent herein, the present invention discloses a method, apparatus and article of manufacture for a computer-implemented system for collecting persistent code coverage data across software versions.

In accordance with the present invention there is provided a method, an apparatus and an article of manufacture for collecting persistent code coverage data across various versions of a software program. Using a computer system, the method for collecting persistent code coverage data for a computer program, which comprises program source code statements, includes the following steps: Identifying the computer program for which the code coverage data should be collected. Then, dividing the program source code statements into one or more code coverage tasks (i.e. coverage tasks). Generating a persistent unique name for each of the code coverage tasks. Inserting coverage points into the computer program source code for each of the code coverage tasks producing so called instrumented program. Compiling and linking the instrumented program into a program executable. Identifying a set of test cases that should be run for the code coverage data collection purposes. Creating a code coverage database to accommodate the code coverage tasks and the identified set of test cases. Running the program executable using the identified set of test cases and writing the information about each test case and the coverage points that are executed into an output file. Processing the information contained in the output file into code coverage data and populating the code coverage database to contain the collected code coverage data.

In accordance with the present invention, the method further includes the following steps: Modifying the computer program to produce a modified version of the computer program source code. Identifying the new, modified or deleted code coverage tasks and generating a persistent unique name for each of the new or modified code coverage tasks. Inserting new or modified coverage points into the modified version of the computer program source code for each of the new or modified code coverage tasks to produce the so called instrumented modified version of the computer program source code. Compiling and linking the instrumented modified version of the computer program source code to produce a modified program executable. Identifying a new set of test cases that should be run for the code coverage data collection purposes on the new and modified code coverage tasks. Altering the code coverage database to accommodate new, modified and deleted code coverage tasks and the new set of test cases. Clearing any code coverage data for the modified code coverage tasks from the code coverage database. Running the modified program executable using the identified new set of test cases and collecting code coverage data for the new and modified code coverage tasks. Updating the code coverage database with the collected code coverage data for the new and modified code coverage tasks. Whereby, the previously collected code coverage data for the non-affected code coverage tasks is preserved for the modified version of the computer program eliminating the need for running the entire test bucket (i.e. test case collection).

Thus, in accordance with the present invention, a computer program is divided into code coverage tasks (i.e. coverage tasks) and those code coverage tasks are given persistent names in such a way that very few of the names change when the program is modified and none of the names change when only comments are changed or added. The persistent code coverage task names, which may be stored in a database, are comprised of the program module name followed by the software version indicator (e.g. version number) in which the coverage task was created followed by a unique task identifier. Each computer program will have associated with it, in the database, a table containing the names of all the coverage tasks that it consists of, the names of test cases that are executed for the code coverage data collection purposes and a coverage status for each of the test cases in respect to each of the coverage tasks.

Thus, it is desirable to provide an effective code coverage data collection and management system which eliminates the need to rerun an entire test case collection to re-collect code coverage data in order to have valid code coverage data.

### BRIEF DESCRIPTION OF THE DRAWINGS

The advantages of the present invention will become more apparent to those of ordinary skill in the art after considering the preferred embodiments described herein with reference to the attached drawings in which like reference numbers represent corresponding parts throughout:

FIG. 1 illustrates an exemplary computer hardware environment that could be used in accordance with the present invention.

FIG. 2 illustrates a flow diagram of the steps performed by a code coverage tool in accordance with the present invention.

FIG. 3 illustrates a code coverage database table after initial load and run of the program executable and the test cases in accordance with the present invention.

FIG. 4 illustrates a code coverage database table after program source code modification in accordance with the present invention.

FIG. 5 illustrates a flow diagram of the steps performed by a code coverage tool during the source code modification in accordance with the present invention.

### DETAILED DESCRIPTION OF THE PREFERRED EMBODIMENT

In the following description of the preferred embodiment, reference is made to the accompanying drawings which form a part hereof, and which is shown by way of illustration a specific embodiment in which the invention may be practiced. It is to be understood that other embodiments may be utilized as structural changes may be made without departing from the scope of the present invention.

Hardware Environment

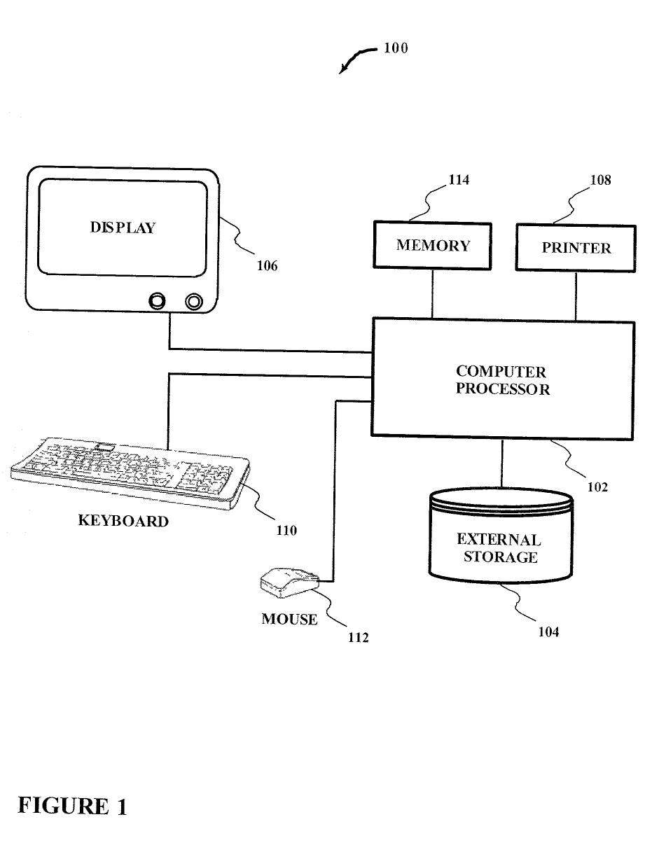

FIG. 1 illustrates an exemplary computer hardware environment that may be used in accordance with the present invention. In the exemplary environment, a computer system 100 is comprised of one or more computer processors 102, one or more external storage devices 104, output devices such as a computer display monitor 106 and a printer 108, a textual input device such as a computer keyboard 110, a graphical input device such as a mouse 112, and a memory unit 114. The computer processor 102 is connected to the external storage device 104, the display monitor 106, the printer 108, the keyboard 110, the mouse 112, and the memory unit 114. The external storage device 104 and the memory unit 114 may be used for the storage of data and computer program code. The external storage device 104 may be a fixed or hard disk drive, a floppy disk drive, a CDROM drive, a tape drive, or other device locally or remotely (e.g. via Internet) connected. The functions of the present invention are performed by the computer processor 102 executing computer program codes, which is stored in the memory unit 114 or the external storage device 104. The computer system 100 may suitably be any one of the types that are well known in the art such as a mainframe computer, a minicomputer, a workstation, or a personal computer. The computer system 100 may run any of a number of well known computer operating systems including IBM OS/390®, IBM AS/400®, IBM OS/2®, Microsoft Windows NT®, Microsoft Windows 2000®, and many variations of OSF UNIX.

Operators of the computer system 100 use a standard operating system interface or other appropriate interface, to transmit electrical signals to and from the computer system 100 that may represent commands for performing specific functions. The functions include, but are not limited to, storage and retrieval of data, storage and execution of applications and test case programs, storage of and access to user information, and search and queries of the databases. For example, these queries may employ Structured Query Language (SQL) and invoke functions performed by Relational Database Management System (RDBMS) software, both well known in the art.

In one embodiment of the present invention, the software program product for which persistent code coverage data should be collected may be written in a high level programming language such as C or C++. However, those of ordinary skill in the art will recognize that present invention is applicable to programs written in other languages such as PASCAL, COBOL, PL/I, FORTRAN, or ASSEMBLER. Those of ordinary skill in the art will also recognize that present invention is applicable to hardware designs written in Hardware Description Languages (HDLs) such as VHDL, or Verilog. The RDBMS software which is used for storing and querying collected code coverage data, may comprise the DB2® Universal Database product offered by IBM Corporation (IBM) for the Microsoft Windows 95®, Microsoft Windows NT®, and Microsoft Windows 2000® operating systems. Those of ordinary skill in the art will recognize, however, that the present invention has application to any RDBMS software or any database software generally, whether or not the software uses SQL. In addition, the present invention is not limited to the Microsoft Windows 95® or Microsoft Windows NT® or Microsoft Windows 2000 operating systems. Rather, the present invention is applicable with any operating system platform.

Generally, the database software and the instructions derived therefrom, and other system software are all tangibly embodied in a computer-readable medium, e.g. one or more of the external storage devices 104. Moreover, the software and the instructions derived therefrom, are all comprised of instructions which, when read and executed by the computer system 100, causes the computer system 100 to perform the steps necessary to implement and/or use the present invention. Under control of an operating system, the software and the instructions derived therefrom may be loaded from the external storage devices 104 into the memory unit 114 of the computer system 100 for use during actual operations.

Thus, the present invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass a computer program accessible from any computer-readable device, carrier, or media. One of skill in the art will appreciate that “media”, or “computer-readable media”, as used here, may include a diskette, a tape, a compact disc, an integrated circuit, a cartridge, a remote transmission via a communications circuit, or any other similar medium useable by computers. For example, to supply software for enabling a computer system to operate in accordance with the invention, the supplier might provide a diskette or might transmit the software in some form via satellite transmission, via a direct telephone link, or via the Internet. Of course, those of ordinary skill in the art will recognize that many modifications may be made to this configuration without departing from the scope of the present invention.

Those of ordinary skill in the art will recognize that the exemplary environment illustrated in FIG. 1 is not intended to limit the present invention. Indeed, those of ordinary skill in the art will recognize that other alternative hardware environments may be used without departing from the scope of the present invention.

Advantages of a code coverage tool is reviewed infra using the following sample program:

Sample Program

| | | |
|---|---|---|
| 1: | sequential statement A | I = 0; |
| 2: | sequential statement B | Read X; |
| 3: | sequential statement C | Z = X * 1.25; |
| 4: | if (condition) { | if (Z > 125) then; |
| 5: | sequential statement D | I = I + 1; |
| 6: | } else { | else; |
| 7: | sequential statement E | I = I − 1; Call Function N; |
| 8: | } | end if; |
| 9: | sequential statement F | Call Cleanup; |

The sample program above is illustrated in pseudo code on the left hand column, and in an actual code on the right hand column. Those of ordinary skill in the art will recognize that sample program can be written in any programming language as stated earlier and is not limited to any particular programming language.

One of the objectives of a code coverage tool is to determine which lines of code in any given program have been tested. Another objective would be to determine a subset of test cases that should be chosen for a regression test purposes. Assume that as an input value, Testcasel provides X=1, Testcase2 provides X=100, and Tetscase3 provides X=101. Testcase1 will exercise all of the lines of code in the sample program except line 5. Testcase2 will also exercise all of the lines of code in the sample program except line 5. However, Testcase3 will exercise all of the lines of code in the sample program except lines 6 and 7. Therefore, in order to get 100% code coverage for this sample program, we will need to run only Testcase1 and Tetscase3. Those of ordinary skill in the art will appreciate that on a very large software program with a large test bucket, a code coverage tool can be very useful in identifying the lines of code which are tested and a subset of test cases that should be run during the regression test. As a result, a significant amount of product development time is saved by not having to run the entire test bucket.

The present invention improves upon the usefulness of a code coverage tool by providing a method for collecting and managing persistent code coverage data across various builds or versions of a software program product. The code coverage data collected for one build or version of the software program will be used during the testing of the next build or version of the software program product. Those of ordinary skill in the art will recognize that a new build or version of a computer program refers to both major and minor code changes in one or more components (e.g. modules) of such program. Major changes include significant amount of new code or new functions and minor changes include less significant code changes such as bug fixes.

A persistent code coverage data collector tool such as the one embodying the methods of the present invention is described next.

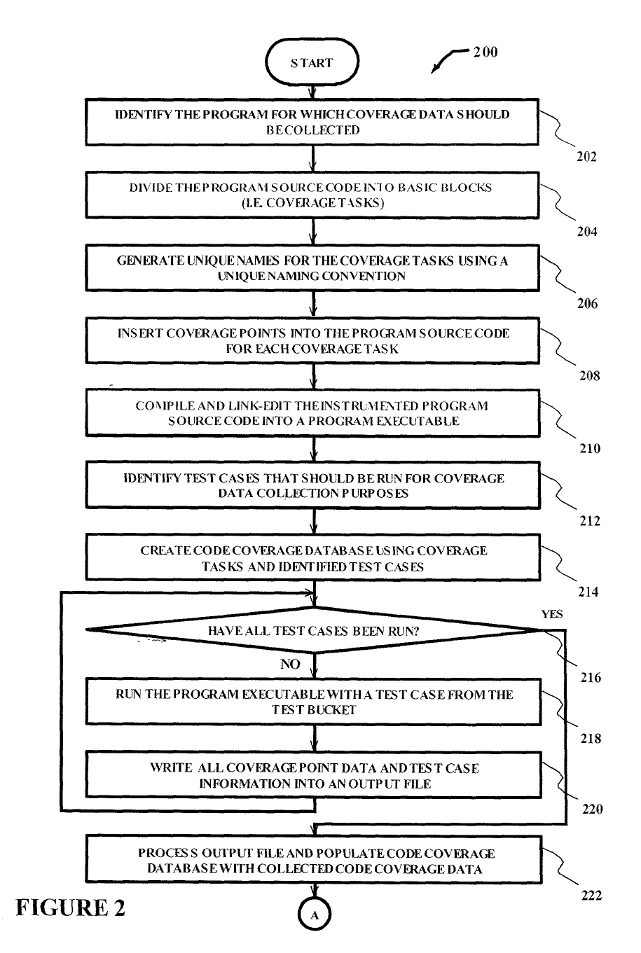

In accordance with the present invention as illustrated in FIG. 2, the program for which persistent code coverage data should be collected is identified in step 202. The program may consist of one or more program modules or the entire software program product. The program source code is then divided into code coverage tasks (i.e. basic blocks) using an instrumentor in step 204. The instrumentor is a conventional tool in the art and is used for identifying code coverage tasks based on information such as program parse tree, block flow analysis and branch condition analysis. A code coverage task is a basic block of code for which an execution of a test returns a true value if the testing requirement of the task is fulfilled and a false value if the testing requirement of the task is not fulfilled. A basic block is a set of consecutive statements with a single entry point (i.e. the first statement) and a single exit point (i.e. the last statement). Control statements such as the “if” statement are considered as a separate block to ease the detection of source code changes that affect the associated blocks (i.e. basic blocks which follow the control statement). Source code changes will be discussed in more detail later. Those of ordinary skill in the art will recognize that there are other alternative ways to divide a program source code into coverage tasks. For example, coverage tasks could be at module level, block level or statement level and could be identified manually rather than automatically and could be based on the user's needs.

Referring back to FIG. 2, the code coverage tasks are then given unique names using a unique naming convention in step 206. The naming convention of the code coverage tasks is in such a way that very few of the coverage task names change when the program is modified and none of the coverage task names change when only comments are changed or added. This is quite different than the prior art naming conventions. For example, in existing code coverage tools the name of a coverage task will be related to the absolute location of the statement at which the coverage task starts (for example line 532 in the program file). Such naming convention results in the names of most of the coverage tasks changing and causes a new and complete code coverage data to be collected for the entire program each time the program source code is modified. However, in accordance with the preferred embodiment, the code coverage task naming convention is based on the relative structure and version of the program module. For example, consider third basic block in version one of module m. This coverage task name will change only if the code in the associated block is modified. If code changes occur in other parts of the program module or the software program product, this coverage task name will not get affected. As a result, code coverage data is collected only for the affected coverage tasks and not the entire program. The code coverage data collected for non-affected coverage tasks from one version of the software program will be used during the testing of the next version of the software program product. So, the persistent code coverage task names in accordance with preferred embodiment are comprised of a given program module name followed by the software version number (i.e. version indicator) in which the coverage task was created followed by a unique block (i.e. coverage task) name. Those of ordinary skill in the art will recognize that other naming conventions could be adopted to distinguish one coverage task from another and prevent changing of all coverage task names due to a source code modification in some of the coverage tasks. The unique coverage task names can be automatically or manually generated.

An example of the coverage task names for the Sample Program above in accordance with the preferred embodiment is shown below:

### EXAMPLE 1

| | | |
|---|---|---|
| 1: | sequential statement A | MOD 1 VER 1 BLOCK 1 |
| 2: | sequential statement B | MOD 1 VER 1 BLOCK 1 |
| 3: | sequential statement C | MOD 1 VER 1 BLOCK 1 |
| 4: | if (condition) { | MOD 1 VER 1 BLOCK 2 |
| 5: | sequential statement D | MOD 1 VER 1 BLOCK 2-1 |
| 6: | } else { | |
| 7: | sequential statement E | MOD 1 VER 1 BLOCK 2-2 |
| 8: | } | |
| 9: | sequential statement F | MOD 1 VER 1 BLOCK 3 |

At step 208 of FIG. 2, coverage points are inserted into the source code of the program at the beginning of each coverage task by the instrumentor. That is, a coverage point is a reference location in the program at which information regarding the execution of the coverage task, which follows, is recorded. In one embodiment, a coverage point is a PRINT statement, which prints information about the code location and other information including the unique name of the coverage task that follows the PRINT statement. In other embodiments, a coverage point can be inserted as a C macro or a function call before or after each coverage task, which records the information regarding the associated coverage task. When the program including the coverage points is executed, the recorded coverage point information indicates whether that point in the program has been executed. In accordance with the present invention, the recorded information includes the persistent coverage task names. The recorded information may be stored in an external storage device 104 (see FIG. 1) for later use. Those of ordinary skill in the art will recognize that insertion of the coverage points into the program source code to facilitate recording and storing of the information at each coverage point is done by conventional methods using an existing code coverage tool or an instrumentor.

Next at step 210, the instrumented program source code (i.e. the source code with the coverage points inserted into it) is compiled and link-edited with appropriate libraries to produce a program executable. Both the compiler and linkage editor are conventional in the art.

At step 212, test cases that should be run for the code coverage data collection purposes, are identified and placed into a test bucket. Those of ordinary skill in the art will recognize that, in addition to the test cases in regression test buckets, there may be a need for writing and preparing new test cases at this step.

Next, using the information regarding the identified test cases and the coverage task names, a code coverage database is created in step 214.

Next, a conventional test coverage tool is used to facilitate test case execution, test coverage determination and test coverage data collection and recordings. At step 216, the test coverage tool determines whether all the test cases in the test bucket have been run. If not, then steps 218 and 220 are performed. If yes, then step 222 is performed.

At step 218, the conventional test coverage tool is used to run the program executable with a test case from the test bucket. When a test case is executed, the code coverage tool determines which coverage task is executed in the program by the test case. At step 220, the test coverage information such as the test case name, the test results, and the information produced at each coverage point in the program executable including the names of the coverage tasks executed by the test case are written into an output file. As various test cases are executed, the output file is updated accordingly. Those of ordinary skill in the art will recognize that various formats of this output file currently known in the art or later come to be known; may be utilized by the preferred embodiment.

At step 222, after all the test cases have been run, the test coverage tool processes the output file and populates the code coverage database with the collected code coverage data.

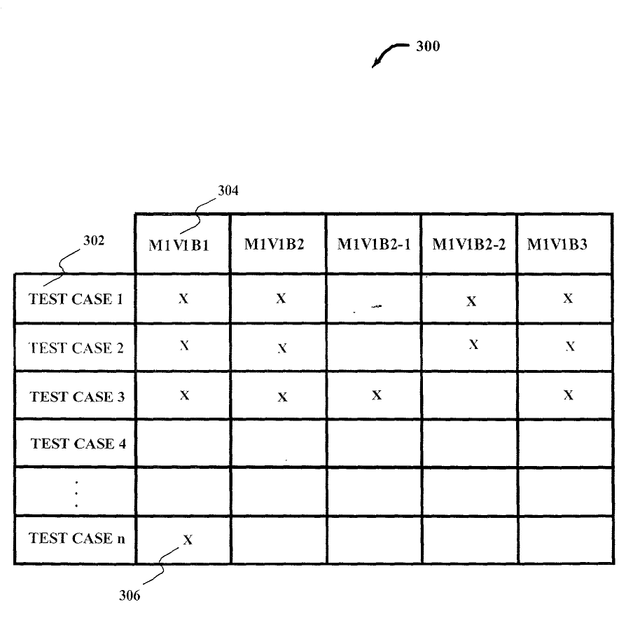

FIG. 3 illustrates a sample code coverage table 300 in accordance with the present invention. In accordance with the present invention, for any given program for which code coverage data is collected, the code coverage database, which may for example be stored in external storage devices 104 (see FIG. 1), includes a code coverage table 300. In the code coverage table 300, the rows of the table are the test case names 302 and the columns are the names of the coverage tasks 304 within the program. In one embodiment of the present invention, an indicator (e.g. X) in a code coverage table cell 306 (i.e. the intersection of a row and column) indicates the coverage status of a given test case for a particular code coverage task. For example, the X in code coverage table cell 306 indicates that TEST CASE n has executed the code coverage task MOD 1 VER 1 BLOCK 1 represented in column M1TV1B1. The code coverage database may include tables that map program modules to coverage tasks and vice versa and additionally, it may include tables that track code coverage history across all builds or versions of the software program. The code coverage database could be queried for test cases that cover a specific coverage task or it could be queried for coverage tasks that are covered by specific test cases or it could be queried for coverage tasks that are not covered by any test cases. It should be noted that while the present discussion assumes the code coverage database is in table form, the present invention is not so limited. For example, the code coverage database may be a flat file.

Now that the code coverage database table has been built and populated with the initial code coverage data, we will discuss the effects of the program source code modifications in the coverage tasks and the code coverage database. When changes are made to the program source code, the coverage tasks and the code coverage database tables as shown in FIG. 3, no longer correctly maps to the modified code. Thus, in accordance with the preferred embodiment, the source code changes must be reflected in new coverage tasks and integrated into the code coverage database, while still preserving the previously collected code coverage data for coverage tasks, which has not been modified. Those of ordinary skill in the art will recognize that detection of the code changes, creation of the new coverage tasks and alteration of the code coverage database to reflect the code changes, can all be done automatically through a conventional or customized code coverage tool with a revision control system.

The program source code modification is discussed in terms of code deletions and code insertions.

Handling Code Deletions:

In accordance with the preferred embodiment, there are two types of code deletions. One type of code deletions does not affect the control structure of the program and the other type does affect the control structure of the program. An example of the type of code deletion, which does not affect the control structure of the program, is when one or more, but not all, of the statements in a given code coverage task (i.e. basic block) are deleted, as illustrated in Example 2 below:

### EXAMPLE 2

| | | |
|---|---|---|
| 1: | sequential statement A | MOD 1 VER 2 BLOCK 1 |
| 3: | sequential statement C | MOD 1 VER 2 BLOCK 1 |
| 4: | if (condition) { | MOD 1 VER 1 BLOCK 2 |
| 5: | sequential statement D | MOD 1 VER 1 BLOCK 2-1 |
| 6: | } else { | |
| 7: | sequential statement E | MOD 1 VER 1 BLOCK 2-2 |
| 8: | } | |
| 9: | sequential statement F | MOD 1 VER 1 BLOCK 3 |

In this case, the statement at line 2 of Example 1 is deleted (i.e. the coverage task named MOD 1 VER 1 BLOCK 1 is modified). This causes the affected coverage task to get a new unique name by changing the version number portion of the name to a new version number and nothing else. For example, the coverage task name MOD 1 VER 1 BLOCK 1 is changed to MOD 1 VER 2 BLOCK 1. The code coverage database table is then altered to reflect this change by renaming the column name corresponding to the old coverage task with the new coverage task name and by clearing any coverage data in that column. As a result, the code coverage database table will show that the new coverage task is no longer tested and requires further coverage data collection. Notice that all other columns in the code coverage database table are unaffected and their corresponding code coverage data is preserved for the new version of the program.

Another example of the type of code deletion, which does not affect the control structure of the program, is when an entire basic block (i.e. coverage task) is deleted, as illustrated in Example 3 below:

### EXAMPLE 3

| | | |
|---|---|---|
| 1: | sequential statement A | MOD 1 VER 1 BLOCK 1 |
| 2: | sequential statement B | MOD 1 VER 1 BLOCK 1 |
| 3: | sequential statement C | MOD 1 VER 1 BLOCK 1 |
| 4: | if (condition) { | MOD 1 VER 1 BLOCK 2 |
| 5: | sequential statement D | MOD 1 VER 1 BLOCK 2-1 |
| 6: | } | |
| 9: | sequential statement F | MOD 1 VER 1 BLOCK 3 |

In this case, the statements at lines 6-8 (i.e. the “else” part of the “if” statement) of Example 1 are deleted (i.e. the coverage task named MOD 1 VER 1 BLOCK 2-2 is deleted). This causes the code coverage database table to be altered by deleting the column name corresponding to the deleted coverage task. Notice that all other columns in the code coverage database table are unaffected and their corresponding code coverage data is preserved for the new version of the program.

An example of the type of code deletion, which does affect the control structure of the program, is when a control statement (e.g. an “if” statement or the “else” clause of an “if” statement) is deleted causing the statements which follow to be executed sequentially, as illustrated in Example 4 below:

### EXAMPLE 4

| | |
|---|---|
| 1: sequential statement A | MOD 1 VER 2 BLOCK 1 |
| 3: sequential statement C | MOD 1 VER 2 BLOCK 1 |
| 4: if (condition) { | MOD 1 VER 1 BLOCK 2 |
| 5: sequential statement D | MOD 1 VER 1 BLOCK 2-1 |
| 6: } | |
| 7: sequential statement E | MOD 1 VER 2 BLOCK 4_{(was VER 1 BLOCK 2-2)} |
| 9: sequential statement F | MOD 1 VER 1 BLOCK 3 |

In this case, the “else” clause of the “if” statement at line 6 of Example 2 is deleted (i.e. execution of the coverage task named MOD 1 VER 1 BLOCK 2-2 is no longer dependent upon the condition of the “if” statement at line 4). This causes the affected coverage task to get a new unique name by changing both the version indicator (e.g. version number) portion of the name and the unique coverage task identifier portion of the name. For example, the coverage task name MOD 1 VER 1 BLOCK 2-2 is changed to MOD 1 VER 2 BLOCK 4. Notice that the new coverage task name is not required to reflect the order of the basic blocks. The code coverage database table is then altered to reflect this change by first deleting the column corresponding to the old coverage task and then adding a new column to reflect the new coverage task name. No coverage data is transferred to the new column from the deleted column. As a result, the code coverage database table will show that the new coverage task is not tested and requires further coverage data collection. Notice that all other columns in the code coverage database table are unaffected and their corresponding code coverage data is preserved for the new version of the program. Also notice that in some cases like Example 4, the new coverage task could be united with the coverage task that immediately follows, to form yet another new coverage task. For example, coverage tasks MOD 1 VER 2 BLOCK 4 and MOD 1 VER 1 BLOCK 3 could be united to form a new coverage task named MOD 1 VER 2 BLOCK 5. In this case, the code coverage database table is altered appropriately to reflect the deleted old coverage tasks and the added new coverage task. Notice that Example 4 also includes the deletion of line 2 as in Example 2, and therefore the coverage task MOD 1 VER 1 BLOCK 1 is renamed to MOD 1 VER 2 BLOCK 1.

Handling Code Insertions:

In accordance with the preferred embodiment and similar to the code deletions, there are two types of code insertions. One type of code insertion does not affect the control structure of the program and the other type does affect the control structure of the program. An example of the type of code insertion, which does not affect the control structure of the program, is when one or more sequential statements are added to an existing basic block (i.e. coverage task). In this case, the affected coverage task gets a new name by changing the version indicator (e.g. version number) portion of its old name to a new version indicator. The code coverage database is then altered by renaming the corresponding column of the table and by clearing the code coverage data from the renamed column. Another example of the type of code insertion, which does not affect the control structure of the program, is when one or more whole new code blocks are added to the program at the end (or before the beginning) of an existing code block. In this case, the new coverage tasks associated with the new blocks are given a complete name with new version number and unique block identifier and the code coverage database is altered to reflect new columns for the new coverage tasks. Notice that all other columns in the code coverage database table are unaffected and the corresponding code coverage data is preserved for the new version of the program.

An example of the type of code insertion, which does affect the control structure of the program, is when a control statement such as an “if” statement and the code blocks attached to it are inserted into the middle of an existing coverage task (i.e. basic block). This causes the affected coverage task to split into other new coverage tasks, as illustrated in Example 5 below:

### EXAMPLE 5

| | | | |
|---|---|---|---|
| 1: | sequential statement A | MOD 1 VER 2 BLOCK 1 | |
| 2: | sequential statement B | MOD 1 VER 2 BLOCK 1 | |
| : | if (condition) { | MOD 1 VER 2 BLOCK 4 | (new) |
| : | sequential statement G | MOD 1 VER 2 BLOCK 4-1 | (new) |
| : | } | | |
| 3: | sequential statement C | MOD 1 VER 2 BLOCK 5 | (new) |
| 4: | if (condition) { | MOD 1 VER 1 BLOCK 2 | |
| 5: | sequential statement D | MOD 1 VER 1 BLOCK 2-1 | |
| 6: | } else { | | |
| 7: | sequential statement E | MOD 1 VER 1 BLOCK 2-2 | |
| 8: | } | | |
| 9: | sequential statement F | MOD 1 VER 1 BLOCK 3 | |

In this case, a new “if” statement and a new basic block are inserted between line 2 and line 3 of Example 1. The affected coverage task MOD 1 VER 1 BLOCK 1 is split into a head portion (i.e. the portion before the new “if” statement and its attached code block) and a tail portion (i.e. the portion after the new “if” statement and its attached code block). The affected coverage task name is retained for the head portion, but a new version number is assigned to it. For example, the coverage task name MOD 1 VER 1 BLOCK 1 is changed to MOD 1 VER 2 BLOCK 1. In addition, new coverage task names with new version number and new block identifier are generated for the inserted new code block and the tail portion of the affected coverage task. For example, new coverage task names MOD 1 VER 2 BLOCK 4 and MOD 1 VER 2 BLOCK 4-1 are generated for the inserted new code blocks and MOD 1 VER 2 BLOCK 5 is generated for the tail portion of the affected coverage task. Those of ordinary skill in the art will recognize that splitting an existing coverage task into other tasks due to code insertions is not limited to the exemplary case above and there are other ways that a coverage task could split into new tasks.

The code coverage database is altered to reflect this coverage task change accordingly. For example, the column for the coverage task MOD 1 VER 1 BLOCK 1 is renamed with new version number (i.e. MOD 1 VER 2 BLOCK 1) and its coverage data is removed. Three new columns corresponding to the new coverage tasks MOD 1 VER 2 BLOCK 4, MOD 1 VER 2 BLOCK 4-1 and MOD 1 VER 2 BLOCK 5 are added to the code coverage database table. Since the new and renamed columns show no coverage data, further testing is required to determine coverage data for these coverage tasks. Notice that all other columns in the code coverage database table are unaffected and their corresponding code coverage data is preserved for the new version of the program.

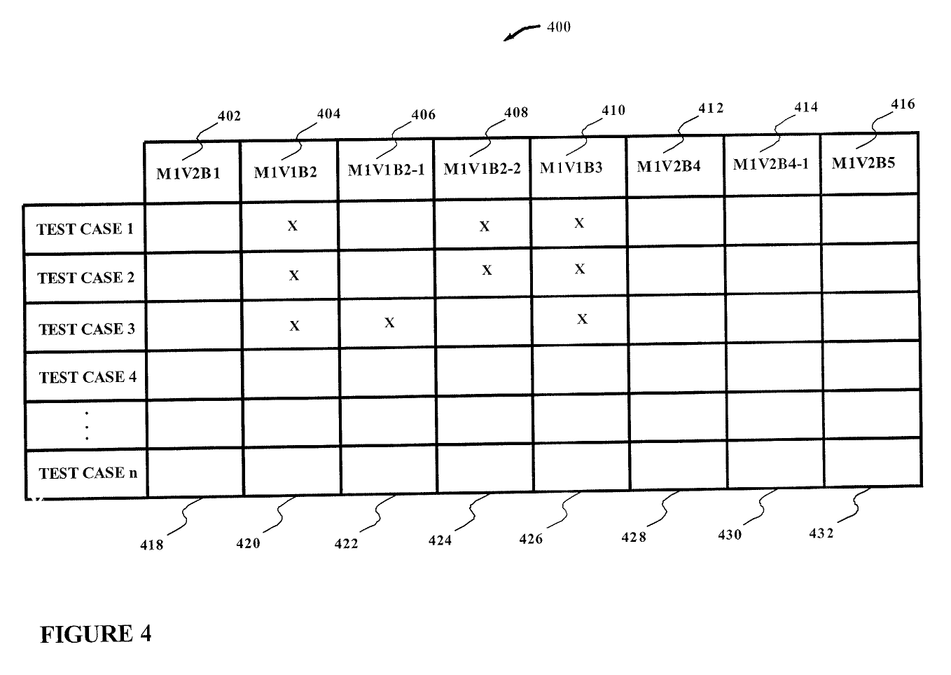

FIG. 4 illustrates the code coverage database table 400 accommodating the new and modified coverage tasks as a result of code changes in Example 5. In particular, the column corresponding to the coverage task MOD 1 VER 1 BLOCK 1 has been renamed to M1V2B1 402, and new column names M1V2B4 412, M1V2B4-1 414, and M1V2B5 416 corresponding to the new coverage tasks MOD 1 VER 2 BLOCK 4, MOD 1 VER 2 BLOCK4-1, and MOD 1 VER 2 BLOCK 5 have been added to the table. Notice that the previously collected code coverage data for the modified coverage task MOD 1 VER 2 BLOCK 1 is cleared from the corresponding column 418. The previously collected code coverage data for all other not affected coverage tasks (i.e. the code coverage data in columns 420, 422, 424 and 426) is preserved for the new version of the program. This eliminates the need to rerun the test cases for code that was not modified. The new columns 428, 430 and 432 contain no coverage data indicating the need for further code coverage data collection. Queries may be made against this updated table to determine what test cases should subsequently be run in order to provide complete code coverage data.

Now, other types of program source code modifications will be addressed. For example, assume that the statement C on line 3 of Example 1 is simply modified or replaced by another statement such as statement CC. In this case, the code modification is treated as a code deletion followed by a code insertion and the affected coverage task and the corresponding code coverage database are handled accordingly.

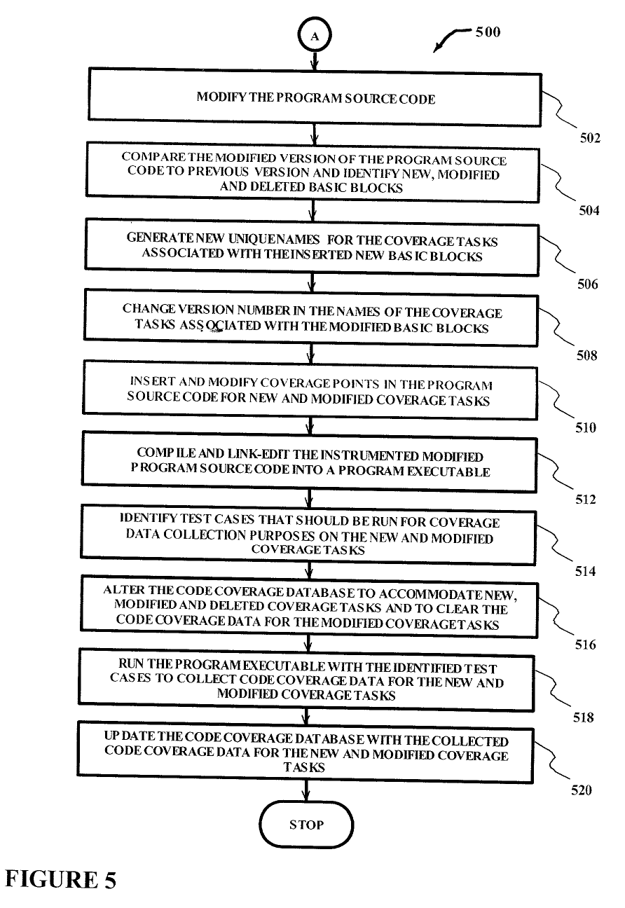

FIG. 5 illustrates the process 500 of handling the program source code modification in accordance with the present invention. In accordance with the preferred embodiment, the program source code is modified in step 502. The modified version of the program source code is then compared to the previous version of the program source code and all the inserted, modified and deleted basic blocks are identified in step 504. Those of ordinary skill in the art will recognize that code comparison and identification of the inserted, modified and deleted basic blocks are done using conventional revision control tools such as RCS (Revision Control System) and CMVC (Configuration Management Version Control).

Next at step 506, new unique names (i.e. names with new version number and new block identifier) are generated for the coverage tasks associated with the inserted new basic blocks. The coverage tasks associated with the modified basic blocks are renamed by changing the version number portion of their names to the new version number in step 508. At step 510, coverage points are inserted into and modified in the new (i.e. modified) version of the program source code to correspond to the new and modified basic blocks. The instrumented modified program source code is then compiled and link-edited into a program executable in step 512.

At step 514, the test cases that should be run for the coverage data collection purposes on the new and modified coverage tasks are identified and collected into a test bucket. Next in step 516, the code coverage database is altered to accommodate new, modified and deleted coverage tasks and the identified test cases. This includes changing of the column names and clearing the code coverage data for the modified coverage tasks, adding new columns for the inserted coverage tasks, deleting the columns for the deleted coverage tasks and adding new rows for the new test cases.

Next, using a conventional test coverage tool, the program executable is run with the identified test cases to collect code coverage data for the new and modified coverage tasks in step 518. The code coverage database is then updated to reflect the code coverage data collected for the new and modified coverage tasks in step 520.

Thus, in accordance with the preferred embodiment, the program source code modifications are reflected in the new and modified coverage tasks and integrated into the code coverage database, while still preserving the previously collected code coverage data for the coverage tasks that are not affected by such source code modifications.

In summary, a code coverage tool implementing the present invention operates in the following context. Initially, a program for which code coverage data should be collected is identified. The program source code is then divided into basic blocks (i.e. coverage tasks) and each coverage task is given a unique name. Coverage points are then inserted into the program source code at the beginning of each coverage task. The program is then compiled and link-edited with appropriate compiler and libraries to produce the program executable. At this point, a determination is made as to how many and which test cases should be run for a code coverage data collection purposes. Then, the code coverage database table is built and the program executable is loaded. Subsequently, the suite of test cases is run to collect coverage point information into an output file. The output file is then processed in order to populate the code coverage database table with the code coverage data per each coverage task. If any source code changes are made, affected and new coverage tasks are identified and the code coverage database is updated accordingly. The code coverage data for non-affected coverage tasks are preserved for testing of the new version of the program. The code coverage database may then be queried to determine which test cases need to be rerun.

The present invention provides an effective code coverage data collection and management system, which eliminates the need to rerun an entire test case collection each time the source code is changed. This saves the programmer development time because the programmer can now run the subset of tests on an executable, compiled from the source code including the modified statements, and does not have to run the complete set of regression tests.

The foregoing description of the preferred embodiment of the present invention has been presented for the purposes of illustration and description. It is not intended to be exhaustive or to limit the invention to the precise form disclosed. Many modifications and variations are possible in light of the above teaching. For example, any type of computer, such as mainframe, minicomputer, or personal computer, or any computer configuration, such as a timesharing mainframe, or a local area network could be used with the present invention.

It is intended that the scope of the invention be limited not by this detailed description, but rather by the claims appended hereto. No claim element herein is to be construed under provisions of 35 USC 112 sixth paragraph, unless the element is recited using “means for” or “steps for”.

What is claimed is:

1. A method using a computer system for collecting persistent code coverage data for a computer program, the computer program comprising program source code statements, the method comprising the steps of:
identifying the computer program for which the persistent code coverage data should be collected;
dividing the program source code statements of said computer program into a plurality of code coverage tasks;
generating a persistent unique name for each of the code coverage tasks of said plurality of code coverage tasks;
inserting coverage points into the computer program source code for each of the code coverage tasks to produce an instrumented program;
compiling and linking the instrumented program into a program executable;
identifying a set of test cases from a plurality of test cases to be run for the code coverage data collection purposes;
creating a code coverage database using the code coverage tasks and the identified set of test cases;
running the program executable with a test case from the identified set of test cases and writing the information about the test case and the coverage points that are executed into an output file, until all the test cases have been run; and
processing the information contained in the output file into code coverage data and populating the code coverage database with said code coverage data.

2. The method of claim 1, wherein generating the persistent unique name for each of the code coverage tasks is done using a unique naming convention.

3. The method of claim 2, wherein the unique naming convention comprises a computer program module name, a version indicator, and a unique code coverage task identifier.

4. The method of claim 1, wherein the code coverage database comprises a table, the table comprising a row for each test case in said identified set of test cases and a column for each code coverage task of said plurality of code coverage tasks, said column comprising an indicator at each row indicating coverage status for said code coverage task.

5. The method of claim 1, wherein said computer program comprises program source code statements written in a hardware description language.

6. The method of claim 1 further comprising the steps of:
modifying the computer program to produce a modified version of the computer program source code;
identifying a plurality of new, modified, and deleted code coverage tasks in said modified version of the computer program source code;
generating a persistent unique name for each of the new and modified code coverage tasks of said plurality of new, modified and deleted code coverage tasks;
inserting coverage points into the modified version of the computer program source code for each of the new and modified code coverage tasks to produce an instrumented modified version of the computer program source code;
compiling and linking the instrumented modified version of the computer program source code into a modified program executable;
identifying a new set of test cases from a plurality of test cases to be run for the code coverage data collection purposes on the new and modified code coverage tasks;
altering the code coverage database to accommodate new, modified and deleted code coverage tasks and the new set of test cases, and clearing any code coverage data for the modified code coverage tasks from said code coverage database;
running the modified program executable with a test case from the identified new set of test cases and collecting code coverage data for the new and modified code coverage tasks, until all the test cases have been run; and
updating the code coverage database with the collected code coverage data for the new and modified code coverage tasks;
whereby the previously collected code coverage data for the non-affected code coverage tasks is preserved from a previous version of the computer program to the modified version of said computer program eliminating the need for running the entire test bucket.

7. The method of claim 6, wherein generating a persistent unique name for each of the modified code coverage tasks is done by changing the version indicator in the names of said modified code coverage tasks.

8. An apparatus for collecting persistent code coverage data for a program, the persistent code coverage data being stored in a code coverage database associated with the program, the program comprising program source code statements, the apparatus comprising:
a computer system having a data storage device connected thereto, wherein the data storage device stores the code coverage database; and
one or more computer programs executed by the computer system for:
identifying the program for which the code coverage data should be collected;
dividing the program source code statements of said program into a plurality of code coverage tasks;
generating a persistent unique name for each of the code coverage tasks of said plurality of code coverage tasks;
inserting coverage points into the program source code for each of the code coverage tasks to produce an instrumented program;
compiling and linking the instrumented program into a program executable;
identifying a set of test cases from a plurality of test cases to be run for the code coverage data collection purposes;
creating a code coverage database using the code coverage tasks and the identified set of test cases;
running the program executable with a test case from the identified set of test cases and writing the information about the test case and the coverage points that are executed into an output file, until all the test cases have been run; and
processing the information contained in the output file into code coverage data and populating the code coverage database with said code coverage data.

9. The apparatus according to claim 8, wherein generating a persistent unique name for each of the code coverage tasks is done using a unique naming convention.

10. The apparatus according to claim 9, wherein the unique naming convention comprises a program module name, a version indicator, a unique code coverage task identifier.

11. The apparatus according to claim 8, wherein the code coverage database comprises a table, the table comprising a row for each test case in said identified set of test cases and a column for each code coverage task of said plurality of code coverage tasks, said column comprising an indicator at each row indicating coverage status for said code coverage task.

12. The apparatus according to claim 8, wherein said program comprises program source code statements written in a hardware description language.

13. The apparatus according to claim 8, wherein the one or more computer programs performed by the computer system further provides for:
modifying the program to produce a modified version of the program source code;
identifying a plurality of new, modified and deleted code coverage tasks in said modified version of the program source code;
generating a persistent unique name for each of the new and modified code coverage tasks of said plurality of new, modified and deleted code coverage tasks;
inserting coverage points into the modified version of the program source code for each of the new and modified code coverage tasks to produce an instrumented modified version of the program source code;
compiling and linking the instrumented modified version of the program source code into a modified program executable;
identifying a new set of test cases from a plurality of test cases to be run for the code coverage data collection purposes on the new and modified code coverage tasks;
altering the code coverage database to accommodate new, modified and deleted code coverage tasks and the new set of test cases, and clearing any code coverage data for the modified code coverage tasks from said code coverage database;
running the modified program executable with a test case from the identified new set of test cases and collecting code coverage data for the new and modified code coverage tasks, until all the test cases have been run; and
updating the code coverage database with the collected code coverage data for the new and modified code coverage tasks;
whereby the previously collected code coverage data for the non-affected code coverage tasks is preserved from a previous version of the program to the modified version of said program eliminating the need for running the entire test bucket.

14. The apparatus according to claim 13, wherein generating a persistent unique name for each of the modified code coverage tasks is done by changing the version indicator in the names of said modified code coverage tasks.

15. An article of manufacture comprising a program storage device readable by a computer and tangibly embodying one or more programs of instructions executable by the computer to perform method steps for collecting persistent code coverage data for a computer program, the computer program comprising program source code statements, the method comprising the steps of:
identifying the computer program for which the code coverage data should be collected;
dividing the program source code statements of said computer program into a plurality of code coverage tasks;
generating a persistent unique name for each of the code coverage tasks of said plurality of code coverage tasks;
inserting coverage points into the computer program source code for each of the code coverage tasks to produce an instrumented program;
compiling and linking the instrumented program into a program executable;
identifying a set of test cases from a plurality of test cases to be run for the code coverage data collection purposes;
creating a code coverage database using the code coverage tasks and the identified set of test cases;
running the program executable with a test case from the identified set of test cases and writing the information about the test case and the coverage points that are executed into an output file, until all the test cases have been run; and
processing the information contained in the output file into code coverage data and populating the code coverage database with said code coverage data.

16. The article of manufacture according to claim 15, wherein generating a persistent unique name for each of the code coverage tasks is done using a unique naming convention.

17. The article of manufacture according to claim 16, wherein the unique naming convention comprises a computer program module name, a version indicator, a unique code coverage task identifier.

18. The article of manufacture according to claim 15, wherein the code coverage database comprises a table, the table comprising a row for each test case in said identified set of test cases and a column for each code coverage task of said plurality of code coverage tasks, said column comprising an indicator at each row indicating coverage status for said code coverage task.

19. The article of manufacture according to claim 15, wherein said computer program comprising program source code statements written in a hardware description language.

20. The article of manufacture according to claim 15 further comprising the steps of:
modifying the computer program to produce a modified version of the computer program source code;
identifying a plurality of new, modified and deleted code coverage tasks in said modified version of the computer program source code;
generating a persistent unique name for the new and modified code coverage tasks of said plurality of new, modified and deleted code coverage tasks;
inserting coverage points into the modified version of the computer program source code for each of the new and modified code coverage tasks to produce an instrumented modified version of the computer program source code;
compiling and linking the instrumented modified version of the computer program source code into a modified program executable;
identifying a new set of test cases from a plurality of test cases that should be run for the code coverage data collection purposes on the new and modified code coverage tasks;
altering the code coverage database to accommodate new, modified and deleted code coverage tasks and the new set of test cases, and clearing any code coverage data for the modified code coverage tasks from said code coverage database;
running the modified program executable with a test case from the identified new set of test cases and collecting code coverage data for the new and modified code coverage tasks, until all the test cases have been run; and
updating the code coverage database with the collected code coverage data for the new and modified code coverage tasks;
whereby the previously collected code coverage data for the non-affected code coverage tasks is preserved from a previous version of the computer program to the modified version of said computer program eliminating the need for running the entire test bucket.

21. The article of manufacture according to claim 20, wherein generating persistent unique name for the modified code coverage tasks is done by changing the version indicator in the names of said modified code coverage tasks.
